(19) United States
(12) Patent Application Publication
(10) Pub. No.: US 2016/0248468 A1
(43) Pub. Date: Aug. 25, 2016

(54) COMMUNICATION DEVICE AND METHOD FOR CALIBRATING AN OSCILLATOR

(71) Applicant: Infineon Technologies AG, Neubiberg (DE)

(72) Inventors: Philipp GREINER, Graz (AT); Gerald HOLWEG, Graz (AT); Christoph STEFFAN, Graz (AT); Thomas HERNDL, Biedermannsdorf (AT)

(21) Appl. No.: 15/051,689

(22) Filed: Feb. 24, 2016

(30) Foreign Application Priority Data
Feb. 24, 2015 (DE) 10 2015 102 600.7

(51) Int. Cl. H04B 1/403; H04W 4/00

(52) U.S. Cl. CPC H04B 1/403; H04W 4/008

(57) ABSTRACT

According to one embodiment, a communication device is described including an oscillator configured to provide a frequency signal, a first transceiver circuit, a second transceiver circuit configured to transmit and receive signals based on the frequency signal and a calibration circuit configured to generate a calibration signal representing the carrier frequency of a signal received by the first transceiver circuit and to calibrate the oscillator based on the calibration signal.

### CROSS-REFERENCE TO RELATED APPLICATION

This application claims priority to German Patent Application Serial No. 10 2015 102 600.7, which was filed Feb. 24, 2015, and is incorporated herein by reference in its entirety.

### TECHNICAL FIELD

The present disclosure relates to communication devices and methods for calibrating an oscillator.

### BACKGROUND

Radio frequency communication is typically based on carrier signals with certain frequencies. Depending on the communication technology used, the requirements on the accuracy of the frequency of a carrier signal, typically provided by an oscillator, may be quite high. While a quartz oscillator offers high accuracy, it may be undesirable to implement a quartz oscillator on a certain communication device such as a chip card due to cost reasons. Accordingly, approaches to achieve high frequency accuracy based on other types of oscillators such as CMOS oscillators are desirable.

### SUMMARY

According to one embodiment, a communication device is provided including an oscillator configured to provide a frequency signal, a first transceiver circuit, a second transceiver circuit configured to transmit and receive signals based on the frequency signal and a calibration circuit configured to generate a calibration signal representing the carrier frequency of a signal received by the first transceiver circuit and to calibrate the oscillator based on the calibration signal.

According to a further embodiment, a method for calibrating an oscillator according to the communication device described above is provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication arrangement according to an embodiment;

FIG. 2 shows a communication device according to an embodiment;

FIG. 3 shows a flow diagram according to an embodiment;

FIG. 4 shows a communication arrangement;

FIG. 5 shows a transceiver according to an embodiment;

FIG. 6 shows a section of the transceiver chip of FIG. 5 in more detail;

FIG. 7 shows an example of a CMOS oscillator according to an embodiment;

FIG. 8 shows an example of the NFC antenna signal a recovered clock signal an uncalibrated oscillator signal;

FIG. 9 illustrates a PLL (phase-locked loop) oscillator calibration based on the recovered clock signal of FIG. 8; and

FIG. 10 shows illustrates a counter based oscillator calibration based on the recovered clock signal of FIG. 8.

### DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

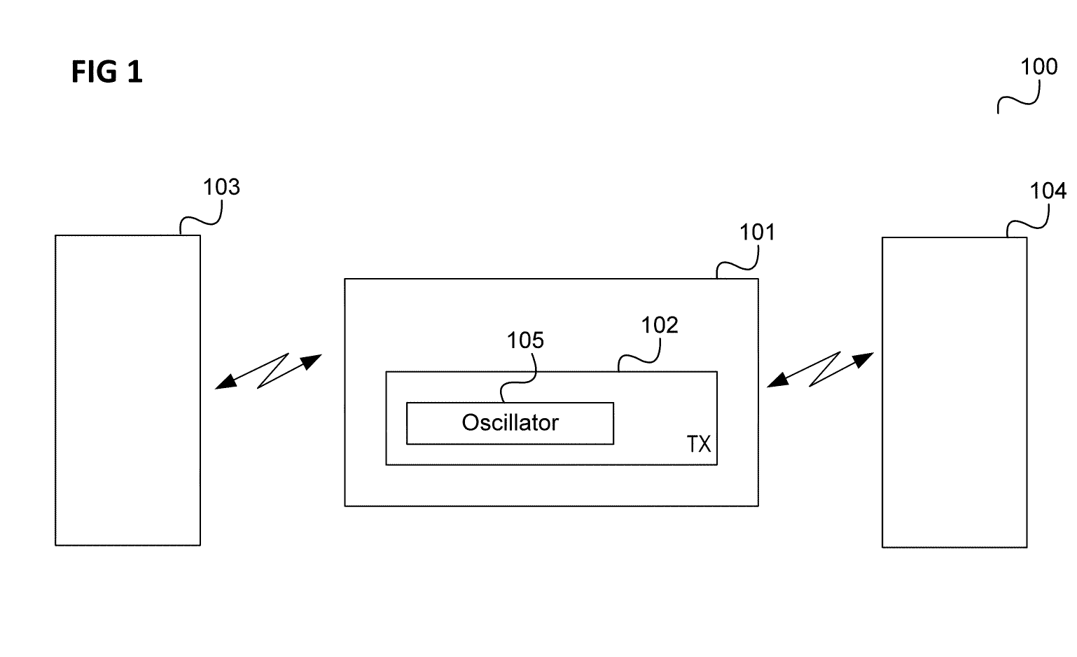

FIG. 1 shows a communication arrangement 100 according to an embodiment.

The communication arrangement 100 includes a communication device 101, for example a chip card, which is equipped with a transceiver 102 which supports NFC (near field communication) for communication with a NFC reading device as well as a further communication technology for communication with a further communication device 104. The further communication technology for example operates in a sub-gigahertz range or in the ISM (Industrial, Scientific and Medical) band. The further communication technology may for example be Bluetooth, WLAN (Wireless Local Area Network) or ZigBee.

For the further communication technology, the transceiver 102 is equipped with an oscillator 105. Since a quartz oscillator is more expensive than a CMOS (complementary metal-oxide-semiconductor) oscillator and cannot be integrated in silicon, a CMOS oscillator is for example used as the oscillator 105.

However, the frequency accuracy of a CMOS oscillator may, due to insufficient long-term stability, not be sufficient for certain transceiver applications, i.e. for certain communication technologies. Due to the strong aging effects of CMOS oscillators, they typically have poor long-term stability.

In the following, an embodiment is described which may for example allow providing a CMOS oscillator with high accuracy for a quartz oscillator free transceiver supporting NFC communication.

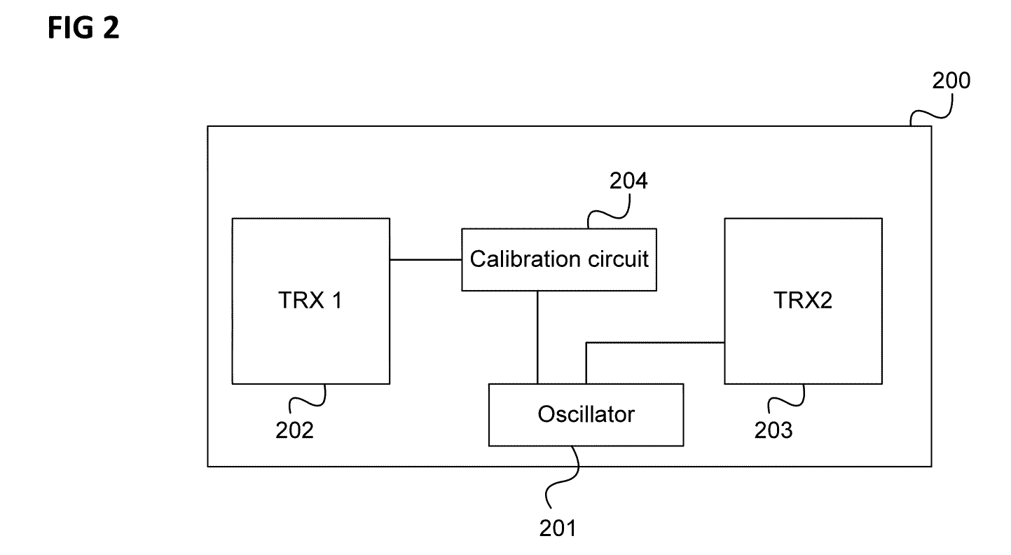

FIG. 2 shows a communication device 200 according to an embodiment.

The communication device 200 includes an oscillator 201 configured to provide a frequency signal, a first transceiver circuit 202 and a second transceiver circuit 203 which is configured to transmit and receive signals based on the frequency signal.

The communication device 200 further includes a calibration circuit 204 configured to generate a calibration signal representing the carrier frequency of a signal received by the first transceiver circuit and to calibrate the oscillator based on the calibration signal.

In other words, a calibration circuit of a communication device (e.g. a chip card) uses the frequency of a carrier signal used by a first transceiver to calibrate an oscillator of a second transceiver. For example, an integrated CMOS oscillator of a transceiver chip which for example supports RFID (radio frequency identification) or NFC (near field communication) chip may be calibrated in a contactless manner. The second transceiver may for example support a communication technology corresponding to the further communication technology supported by the transceiver 102 and the first transceiver may support NFC and receive signals according to NFC from an NFC reading device as described with reference to FIG. 1.

The communication device may for example include a transceiver including the first transceiver circuit and the second transceiver circuit.

For example, the transceiver is implemented by a transceiver chip and the first transceiver circuit and the second transceiver circuit are integrated on the transceiver chip.

According to one embodiment, the calibration signal is a clock signal having a frequency corresponding to the carrier frequency of the signal received from the first transceiver. For example, the clock signal has a frequency equal to the carrier frequency of the signal received from the first transceiver or a certain multiple of the carrier frequency of the signal received from the first transceiver.

The calibration circuit is for example configured to calibrate the oscillator by setting the oscillator to a frequency corresponding to the carrier frequency. For example, the calibration circuit sets the oscillator to a frequency equal to the carrier frequency or to a certain multiple of the carrier frequency.

For example, the oscillator is a digitally controlled oscillator and the calibration circuit is configured to set the oscillator to the frequency corresponding to the carrier frequency by determining a control value which sets the oscillator to the frequency and controlling the oscillator by means of the control value.

The communication device may further include a memory and a memory controller configured to store the determined control value in the memory.

The memory is for example a non-volatile memory.

According to one embodiment, the calibration circuit includes a clock recovery circuit configured to generate the clock signal based on the signal received from the first transceiver circuit.

According to one embodiment, the communication device further includes a first antenna wherein the first transceiver circuit is configured to send and receive signals via the first antenna and the clock recovery circuit is configured to generate the clock signal from an alternating magnetic field to which the first antenna is exposed.

The first transceiver circuit may for example be configured to transmit and receive signals according to a near-field communication.

The signal received by the first transceiver is for example a signal transmitted by a near field communication reading device.

According to one embodiment, the first transceiver circuit implements a passive transceiver and the second transceiver circuit implements an active transceiver.

The first transceiver circuit is for example configured to send signals using load modulation.

The oscillator is for example a CMOS (complementary metal-oxide-semiconductor) oscillator.

The oscillator may for example be an LC oscillator.

According to one embodiment, the second transceiver circuit is configured to transmit and receive signals based on a carrier signal corresponding to the frequency signal provided by the oscillator.

The second transceiver circuit is for example configured to send signals using phase modulation, amplitude modulation or frequency modulation.

According to one embodiment, the first transceiver circuit supports a first communication technology and the second transceiver supports a second communication technology different from the first communication technology.

For example, the second communication technology allows a higher communication range than the first communication technology.

The second communication technology may for example allow a higher bandwidth than the first communication technology.

According to one embodiment, the first transceiver circuit is configured to send and receive signals via a first antenna and the second transceiver circuit is configured to send and receive signals via a second antenna and wherein the first transceiver circuit is configured to operate based only on power received via the first antenna and the second transceiver circuit requires a power supply. In other words, the second transceiver circuit is not powered by power received via the second antenna. For example, only the first transceiver circuit (e.g. a passive NFC transceiver front end) is capable of extracting power from a reader field, while the second transceiver circuit must be supplied either via power extracted from the NFC-field from the first transceiver or from a battery.

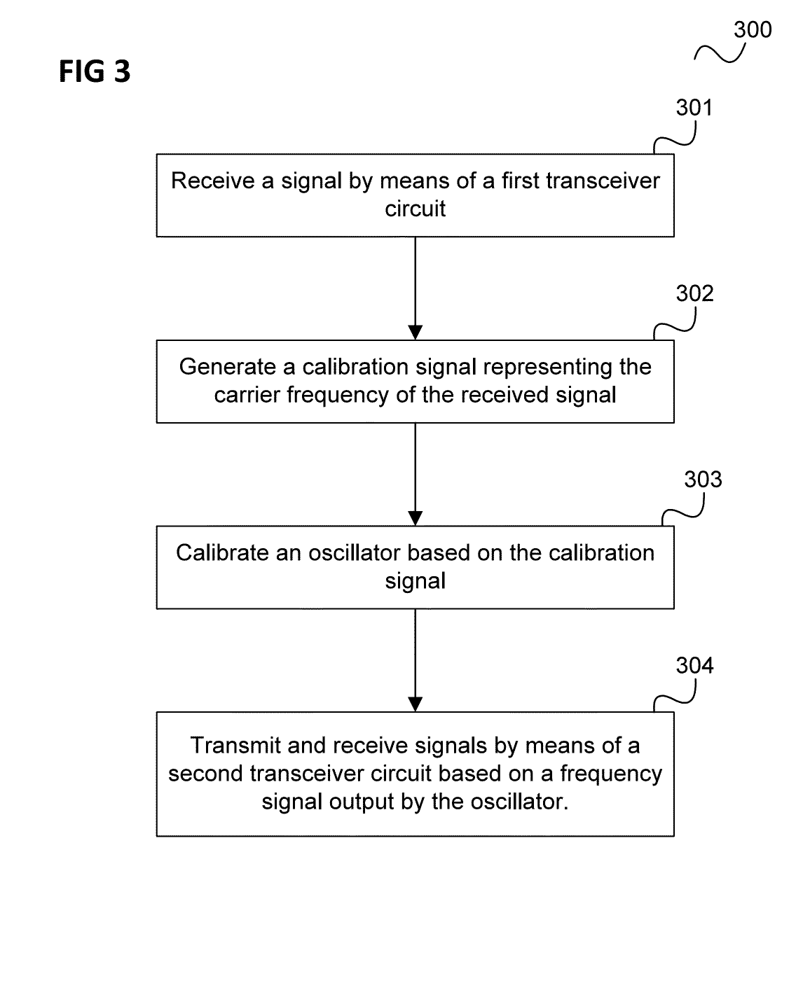

The communication device 200 for example carries out a method as illustrated in FIG. 3.

FIG. 3 shows a flow diagram 300 according to an embodiment.

The flow diagram 300 illustrates a method for calibrating an oscillator.

In 301, a signal is received by means of a first transceiver circuit.

In 302, a calibration signal representing the carrier frequency of the received signal is generated;

In 303, an oscillator is calibrated based on the calibration signal

In 304, signals are transmitted and received by means of a second transceiver circuit based on a frequency signal output by the oscillator.

It should be noted that embodiments described in context of the communication device 200 are analogously valid for the method illustrated in FIG. 3 and vice versa.

In the following, embodiments are described in more detail.

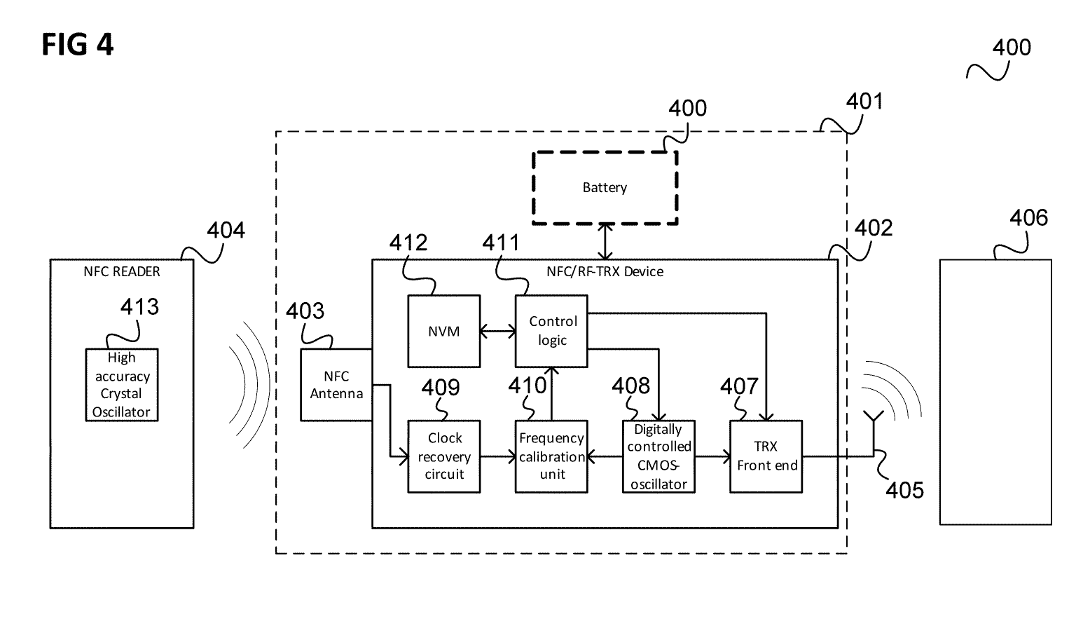

FIG. 4 shows a communication arrangement 400.

Similarly to FIG. 1, the communication arrangement 400 includes a communication terminal 401 having a transceiver 402 which supports NFC communication and a further radio-frequency (RF) communication technology. It includes a NFC antenna 403 via which the transceiver 402 can communicate with an NFC reading device 404 and a further antenna 405 via which it can communicate with a further communication device 406 using the further (RF) communication technology. It should be noted that the NFC reading device 404 and the further communication device 406 may be the same device. For example, according to one embodiment, the communication terminal 401 uses the further communication technology to communicate at a higher bandwidth with the NFC reading device 404 than possible with the NFC communication.

The transceiver 402 is for example implemented by a transceiver chip for the further communication which includes (i.e. supports) in addition an NFC communication functionality i.e. an RFID (radio frequency identification) communication functionality.

The functionality of the further communication technology is provided by a transceiver frontend 407 coupled to the further antenna 405. Instead of a quartz oscillator, the transceiver includes a CMOS oscillator 408 which provides a frequency signal to the transceiver (TRX) frontend as reference frequency. The CMOS oscillator 408 is a digitally controlled oscillator (DCO) and can thus be set by means of a digital value to a desired frequency. Additionally, a variable frequency divider could be used to scale the oscillator frequency to the right (lower) reference frequency.

The NFC/RFID communication functionality is used for calibration of the CMOS oscillator 408 before it is used for communication. This is for example necessary due to variations in the manufacturing of the CMOS oscillator 408. Specifically, the NFC reading device 404 emits a carrier signal with a certain frequency which causes an alternating magnetic field at the NFC antenna 403 of this frequency. This frequency is for example given by a high accuracy frequency crystal oscillator 413 of the NFC reading device, e.g. 13.56 MHz. The transceiver 402 includes a clock recovery circuit 409 which generates a clock signal from the alternating magnetic field at the NFC antenna 403. The clock signal has a frequency equal to the frequency of the alternating magnetic field (and thus for example 13.56 MHz with high accuracy) and is used by a frequency calibration circuit 410 to calibrate the CMOS oscillator 408 via a control logic 411. Specifically, the frequency calibration unit 410 adjusts the digital control value of the CMOS oscillator 408 provided by the control logic 411 such that the frequency of the CMOS oscillator 408 matches the reference frequency generated from the alternating magnetic field, i.e. the frequency of the clock signal generated by the clock recovery circuit 409. After this frequency matching the digital control value of the CMOS oscillator 408 is stored (e.g. by the control logic 411) in a non-volatile memory 412. This allows maintaining the calibration of the CMOS oscillator 408 even when the connection to the NFC reader 404 and a power supply (e.g. from a battery 413) is interrupted.

The calibration procedure as described above carried out by the clock recovery circuit 409 and the frequency calibration unit 410 may be performed initially, e.g. after transceiver 402 has been switched on for the first time, but may also be carried out each time the transceiver 402 is within the field of an NFC/RFID reader. This allows avoiding a long-term drift of the CMOS oscillator. The calibrated CMOS oscillator can generate an accurate reference frequency which is also available without the transceiver being within the field of an NFC/RFID reader and may be used for the operation of the transceiver frontend 407.

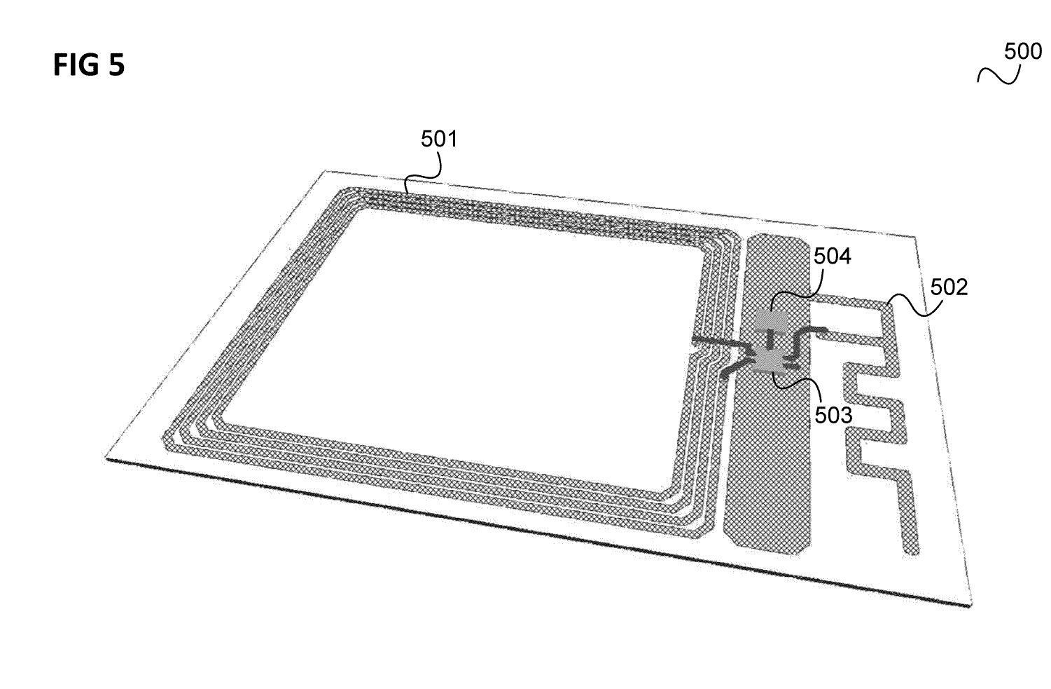

The transceiver 402 may for example be implemented by a transceiver chip as illustrated in FIG. 5.

FIG. 5 shows a transceiver device 500, e.g. a chip card, according to an embodiment.

The transceiver device 500 includes an NFC antenna 501, a further antenna 502 and a transceiver chip 503 coupled to the antennas 501, 502. The transceiver chip 503 supports NFC communication via the NFC antenna 501 and communication according to a further communication technology via the further antenna 502.

Optionally, the transceiver device 500 may include a battery 504 coupled to the transceiver chip 503 which allows the operation of the transceiver chip 503 even if the transceiver device 500 is not supplied with power by an NFC reader field. The battery 504 is for example a rechargeable thin film lithium battery.

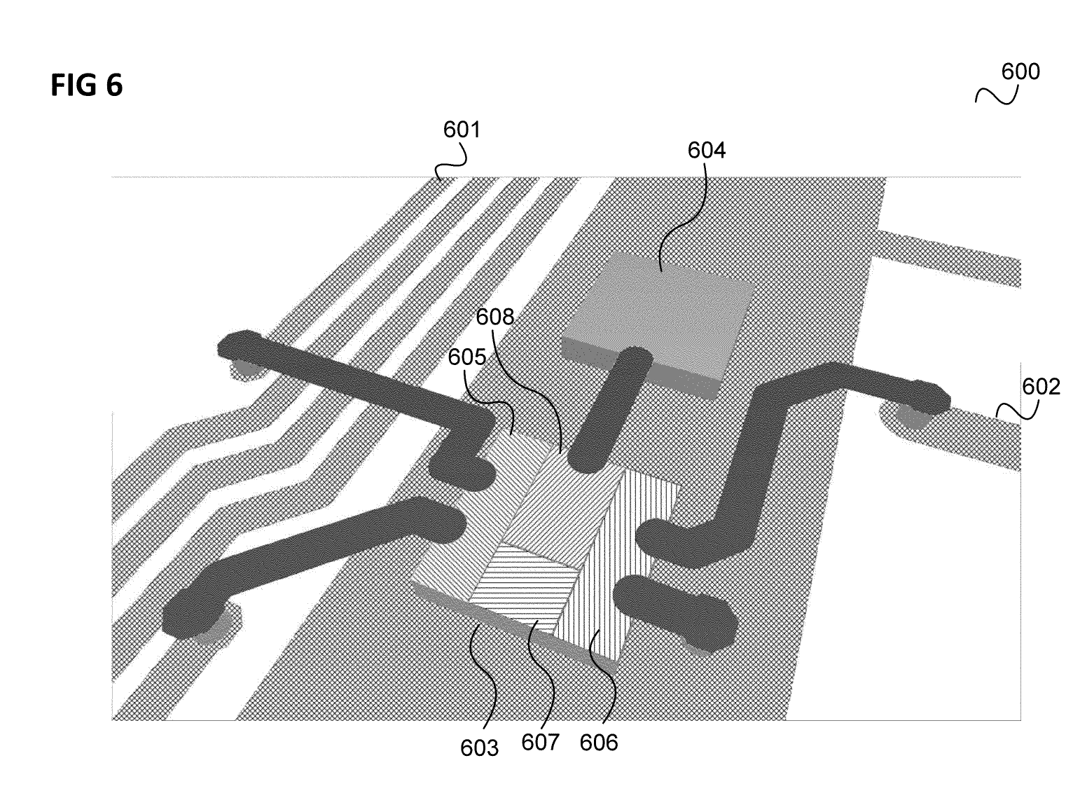

The transceiver chip 503 is shown in more detail in FIG. 6.

FIG. 6 shows a section of the transceiver device 500 in more detail. Specifically, FIG. 6 shows a part of an NFC antenna 601 corresponding to NFC antenna 501, a part of a further antenna 602 corresponding to the further antenna 502, a transceiver chip 603 corresponding to transceiver chip 503 and a battery 604 corresponding to battery 504.

The transceiver chip 603 includes an NFC transceiver circuit 605, a further transceiver circuit 606, a CMOS oscillator (or CMOS clock circuit) 607 and further components 608 for example including logic components and a non-volatile memory, e.g. corresponding to memory 412.

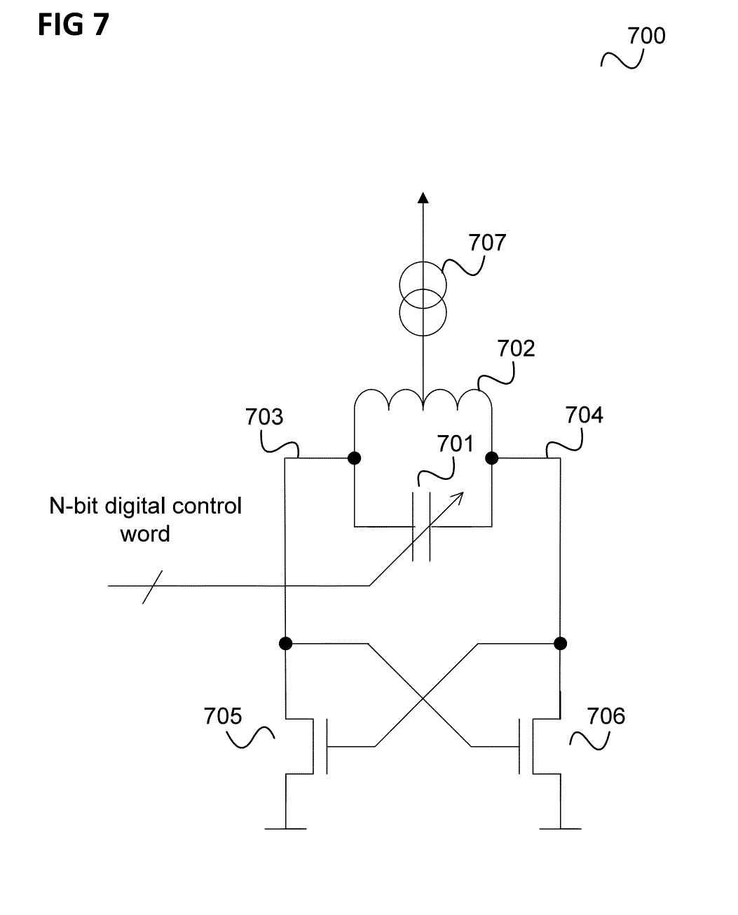

FIG. 7 shows an example of a CMOS oscillator 700 according to an embodiment.

The CMOS oscillator 700 may for example be used as the digitally controlled CMOS oscillator 408. It is controlled by an N-bit digital control word that controls the capacity of a capacitor 701 which is connected in parallel to an inductivity 702 between a first node 703 and a second node 704.

The first node 703 is connected to ground via a first field effect transistor 705 whose gate is connected to the second node 704. The second node 704 is connected to ground via a second field effect transistor 706 whose gate is connected to the first node 703. A center tapping of the inductor 702 is connected via a current source 707 to the output of the CMOS oscillator 700.

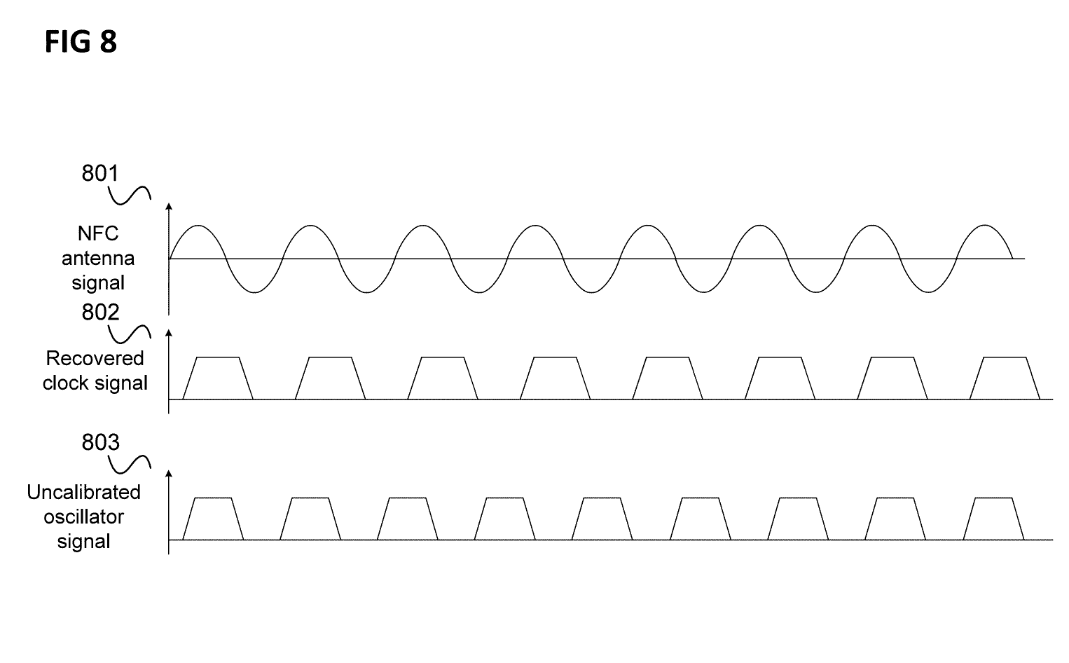

FIG. 8 shows an example of the NFC antenna signal in a first graph 801, the clock signal recovered from the NFC antenna signal in a second graph 802 and an example of an uncalibrated oscillator signal 803, i.e. an example of the output signal of the oscillator 408 before its calibration.

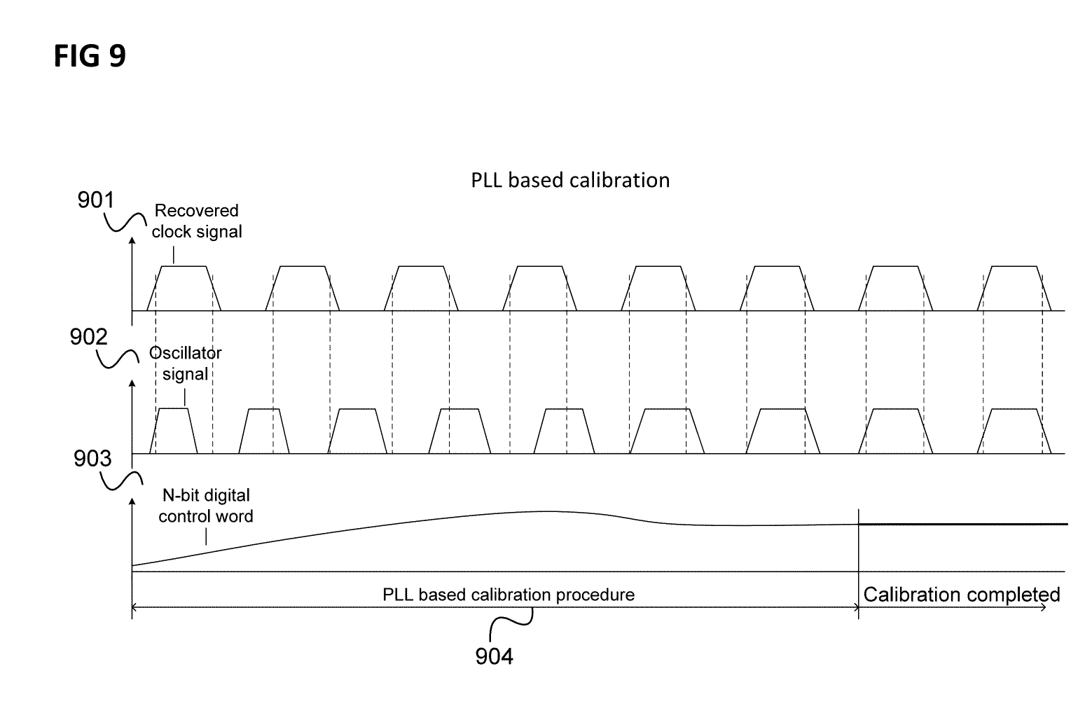

FIG. 9 illustrates a PLL (phase-locked loop) calibration of the oscillator 408 based on the recovered clock signal of FIG. 8.

A first graph 901 shows the recovered clock signal and a second graph 902 shows the oscillator signal as it is generated according to an n-bit digital control word as indicated in a third graph 903. As can be seen, after a time of a PLL based calibration procedure 904, the oscillator signal and the recovered clock signal are aligned and the calibration is completed.

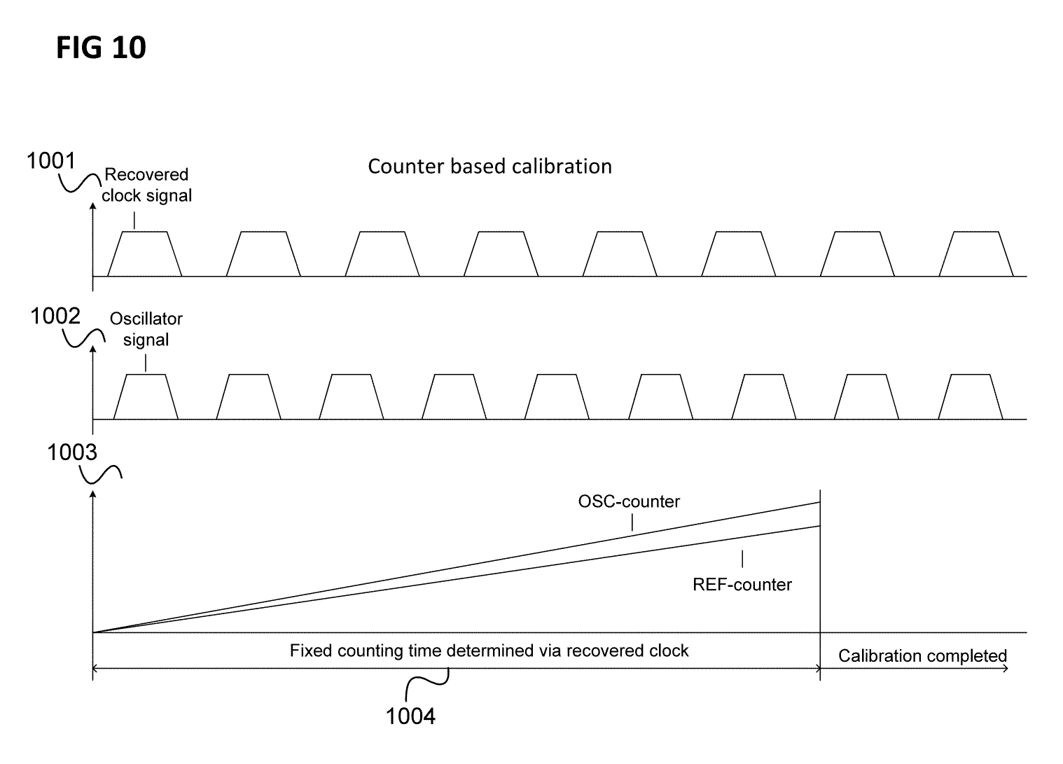

FIG. 10 illustrates a counter based calibration of the oscillator 408 based on the recovered clock signal of FIG. 8.

A first graph 1001 shows the recovered clock signal and a second graph 1002 shows the oscillator signal. During a fixed counting time 1004 determined via the recovered clock signal, the cycles of the recovered clock signal (REF-counter) and the oscillator signal (OSC-counter) are counted as shown in a third graph 1003. According to the counter values at the end of the counting time, the oscillator is calibrated.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A communication device, comprising:
an oscillator configured to provide a frequency signal;
a first transceiver circuit;
a second transceiver circuit configured to transmit and receive signals based on the frequency signal; and
a calibration circuit configured to generate a calibration signal representing the carrier frequency of a signal received by the first transceiver circuit and to calibrate the oscillator based on the calibration signal.

2. The communication device of claim 1, further comprising:
a transceiver comprising the first transceiver circuit and the second transceiver circuit.

3. The communication device of claim 2,
wherein the transceiver is implemented by a transceiver chip and the first transceiver circuit and the second transceiver circuit are integrated on the transceiver chip.

4. The communication device of claim 1,
wherein the calibration signal is a clock signal having a frequency corresponding to the carrier frequency of the signal received from the first transceiver.

5. The communication device of claim 1,
wherein the calibration circuit is configured to calibrate the oscillator by setting the oscillator to a frequency corresponding to the carrier frequency.

6. The communication device of claim 5,
wherein the oscillator is a digitally controlled oscillator and the calibration circuit is configured to set the oscillator to the frequency corresponding to the carrier frequency by determining a control value which sets the oscillator to the frequency and controlling the oscillator by means of the control value.

7. The communication device of claim 6, further comprising:
a memory and a memory controller configured to store the determined control value in the memory.

8. The communication device of claim 7,
wherein the memory is a non-volatile memory.

9. The communication device of claim 1,
wherein the calibration circuit comprises a clock recovery circuit configured to generate the clock signal based on the signal received from the first transceiver circuit.

10. The communication device of claim 1, further comprising:
a first antenna wherein the first transceiver circuit is configured to send and receive signals via the first antenna and wherein the clock recovery circuit is configured to generate the clock signal from an alternating magnetic field to which the first antenna is exposed.

11. The communication device of claim 1,
wherein the first transceiver circuit is configured to transmit and receive signals according to a near-field communication.

12. The communication device of claim 1,
wherein the signal received by the first transceiver is a signal transmitted by a near field communication reading device.

13. The communication device of claim 1,
wherein the first transceiver circuit implements a passive transceiver and the second transceiver circuit implements an active transceiver.

14. The communication device of claim 1,
wherein the first transceiver circuit is configured to send signals using load modulation.

15. The communication device of claim 1,
wherein the oscillator is a complementary metal-oxide-semiconductor oscillator.

16. The communication device of claim 1,
wherein the oscillator is an LC oscillator.

17. The communication device of claim 1,
wherein the second transceiver circuit is configured to transmit and receive signals based on a carrier signal corresponding to the frequency signal provided by the oscillator.

18. The communication device of claim 1,
wherein the second transceiver circuit is configured to send signals using phase modulation, amplitude modulation or frequency modulation.

19. The communication device of claim 1,
wherein the first transceiver circuit supports a first communication technology and the second transceiver supports a second communication technology different from the first communication technology.

20. The communication device of claim 1,
wherein the second communication technology allows a higher communication range than the first communication technology.

21. The communication device of claim 1,
wherein the second communication technology allows a higher bandwidth than the first communication technology.

22. The communication device of claim 1,
wherein the first transceiver circuit is configured to send and receive signals via a first antenna and the second transceiver circuit is configured to send and receive signals via a second antenna and wherein the first transceiver circuit is configured to operate based only on power received via the first antenna and the second transceiver circuit requires a power supply.

23. A method for calibrating an oscillator, the method comprising:
receiving a signal by a first transceiver circuit;
generating a calibration signal representing the carrier frequency of the received signal;
calibrating an oscillator based on the calibration signal; and
transmitting and receiving signals by a second transceiver circuit based on a frequency signal output by the oscillator.
